(19) United States
(12) Patent Application Publication
(10) Pub. No.: US 2022/0023678 A1
(43) Pub. Date: Jan. 27, 2022

(54) Protective Face Covering System

(71) Applicant: Durapan, LLC

(72) Inventor: Reef Mowers, San Jose, CA (US)

(21) Appl. No.: 17/385,697

(22) Filed: Jul. 26, 2021

Related U.S. Application Data
(60) Provisional application No. 63/056,236, filed on Jul. 24, 2020.

(51) Int. Cl. A62B 18/08; A41D 13/11; A62B 23/02

(52) U.S. Cl. CPC A62B 18/084; A62B 23/025; A41D 13/1169

(57) ABSTRACT

A protective face covering system is provided, which includes one or both of a substantially transparent face shield and an air filtering face mask. Both the face shield and face mask are removably positionable in front of the face of the user without straps or bands. A dual adhesive engagement holds the face mask in a sealed contact with the face of the user, and one of a secondary adhesive engagement or a slit engaged to the eyewear of the user holds the face shield in front of the face of the user.

This application claims priority to U.S. Provisional Patent Application Ser. No. 63/056,236, filed on Jul. 24, 2020, which is incorporated herein in its entirety by this reference thereto.

### BACKGROUND OF THE INVENTION

### 1. Field of the Invention

The present invention relates to facial personal protective equipment. More particularly, the invention relates to facial protective equipment which requires no ties or elastic bands to operatively engage facial protection to the face of the user, as well as a system for the wide and easy deployment of such facial protective devices from conventional rolled dispensers or boxes.

### 2. Prior Art

When dealing with a highly infectious disease which is easily passed from person to person, the wearing of personal protective equipment (PPE), such as facial masks and/or shields, is recommended. The wearing of such PPEs has been shown to prevent the expelling and inhaling of airborne viruses and bacteria and the like. Such face coverings, when worn properly, provide a first line of defense for the airborne transmission of diseases.

Shield type protective face coverings conventionally employ a substantially transparent shield positioned in front of the face and eyes of the wearer. The transparent shield, so positioned, forms a barrier to the communication of pathogens in the air surrounding the wearer from reaching the eyes, nose and mouth of the wearer. Such shields are conventionally held in place by a headband engaged to an upper end of the deployed shield.

Flexible nose and mouth coverings, in the form of fabric type masks, are conventionally worn in a contact with the face of the user in a position to cover the nose and the mouth of the wearer. These flexible coverings conventionally employ a tight mesh which will pass air to and from the nose and mouth of the user but which will substantially prevent the passage of droplets of atomized fluids, which the wearer might breathe, from surrounding air. Further, they also prevent the wearer from projecting such fluids into the air where others may come in contact with them.

Such flexible coverings are well known and conventionally employ elastic straps or straps which the user may tie once the mask is properly positioned. They may also be layered and include filter materials adapted to catch and destroy pathogens which may be airborne or might become airborne upon a cough or sneeze of the wearer.

In some cases, it may be desirable for a user to employ both a clear protective shield, which covers a face mask, to protect themselves and others from potential infection. Such will provide both a clear shield which will help to protect the eyes from airborne pathogens and the flexible mask which will filter such and prevent airborne transmission.

However, making such face shields and/or masks available, in a convenient fashion to users, is a significant problem. Travelers in airports, visitors to buildings and medical centers, meetings, or even concerts, all must either bring their own facial protection or depend on the venue which they are visiting to provide it. Such is not conducive to maximizing the wearing of such protection to minimize the potential of passing pathogens to visitors.

The forgoing examples of related art in facial coverings and limitations related therewith are intended to be illustrative and not exclusive, and they do not imply any limitations on the system for deploying facial protective coverings described and claimed herein. Various limitations of the related art will become apparent to those skilled in the art upon a reading and understanding of the specification below and the accompanying drawings.

### SUMMARY OF THE INVENTION

The system herein disclosed and described provides a solution to the shortcomings in prior art in PPEs used for facial covering. The system herein provides for easy deployment of and encouragement of the use of protective facial coverings which help to provide an impediment to the spread of pathogens. The system herein achieves such through the provision of facial coverings in the form of substantially transparent flexible face shields and air-filtering masks. Such may be dispensed from containers such as boxes or other holders, or they may be positioned in rolls, thereof, in existing conventional towel dispensers and similar dispensing equipment.

The system herein provides the option for a two-stage PPE for the user. One mode includes air filtering facial masks and/or wearable substantially clear face shields individually, or the masks and face shields may be combined to enhance the protection of the user. The flexible masks may be dispensed individually from a stack or box or from a plurality of individual face shields whereby individual shields may be dispensed sequentially from a dispensing component. In another mode of dispensing the flexible air filtering masks, they may be dispensed from a roll thereof having frangible connections.

For the face shields, such have a body formed of a layer of substantially clear polymeric or plastic material through which the user can easily see their surroundings once positioned on the face of the user. The face shields may be dispensed individually from a stack or a plurality thereof in a container such as a box. Also, and particularly preferred for ease of dispensing, because the polymeric bodies in a stack tend to sick together, is the formation of rolls having a plurality of shields in individual which are rendered separable from the dispensing roll by a specially configured frangible edge.

In use, a shield or mask may be removed from a stack thereof in a box, or in one mode of the system, they may be pulled from a roll thereof where the individual shields tend not to stick together. The shields, in a particularly preferred mode of the system, may be dispensed from rolls which are rotationally engaged in a housing, such as a conventional paper towel dispenser. Where such dispensers will automatically dispense a face shield or in some cases a face mask from a roll, the individual face masks or face shields will automatically project from the dispenser housing once a button is pressed or a proximity switch is actuated by a user.

Preferably, each face shield or mask is held in a clean container, or where required, a sterile container. Where sealed in a sterile container, such as paper or plastic bag like containers, that container is easily opened by the user to allow the user to remove the mask or face shield from a sealed cavity within the container. However, because such face shields and filtering masks are conventionally employed in a fashion not requiring total sterility, they may simply be dispensed without coverings with more convenience such as from stacks or rolls thereof.

Additionally preferred in all modes of the system, is the provision of such air-filtering face masks and such protective shields, in a form which requires no headbands, straps, or elastic, to operatively position it on the face of the user. Instead, the face shields herein are provided with adhesive sections located thereon, which are adapted in position to adhesively engage the face, such as preferably the temple area of the face of a user. Such adhesive may be a double adhesive with a protective release layer on each.

In an alternative mode of the face shields, an aperture defined by a slit formed in opposing mounting areas on the body of the face shield are adapted to hold the face shield in place through a frictional engagement on the temples of eyewear. Experimentation has found that a slit defining the aperture worked better then a hole, because the plastic material on both sides of the slit form a frictional, substantially non slip engagement on the temples of the eyewear of the user. This frictional engagement better holds the transparent shield in a curved positioning in front of the face of the user. In either mode of facial engagement of the face shield to the user, no straps or ties or elastic are required which are or can become uncomfortable over long hours of use.

The air filtering face masks are likewise provided with a mask body formed of air filtering fabric or material which is well known and widely employed. The face mask body has a shape and perimeter area which has one or preferably a plurality of annular adhesive areas positioned around the perimeter area of the mask body formed of the air filtering material forming the mask body. The adhesive is in locations adapted to adhesively engage the perimeter area of the mask body to the cheeks of the user, and the jaw or neck of the user. By perimeter area herein is meant an area between an inner edge of a first adhesive area and the exterior perimeter edge of the face mask body.

In the particularly preferred mode of the face masks herein, a first adhesive area surrounded by a second adhesive area is provided. This allows users to remove the mask temporarily and where the first adhesive area may have become unuseable, the second adhesive area may be exposed and provide a secondary adhesive connection to the face of the user. As with the face shield, no strings or elastic straps are required to hold the face mask in position on the face of the user.

Additionally provided, by such an adhesive engagement of the masks to the face of the user, is a sealed connection over the bridge of the nose of the user, without the need for a wire or the like as in conventional face masks. The first and second adhesive areas are shaped with an arched area, which has been found in experimentation to provide an especially good seal when engaged to the face of the user over the bridge area of the nose. This substantially air tight seal helps prevent air leakage as well as fogging of eyewear and drying of the eyes of the user caused by long term airflow which occurs with conventional unsealed protective facial masks.

With respect to the above description, before explaining at least one preferred embodiment of the herein disclosed protective face covering system in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other strapless facial covering systems and for carrying out the several purposes of the present disclosed device and system herein. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. Finally, unless provided with a different respective definition, the term “substantially” herein means plus or minus five percent.

It is an object of this invention to provide an easily engaged air filtering face mask which requires no straps or elastic bands to hold it in place.

It is a further object of this invention to provide a substantially transparent face shield formed of plastic or polymeric material, which provides an engagement to the face of the user where that engagement does not require ties, elastic, or straps to hold it in place.

It is an object of this invention to provide such face masks and shields configured in shapes and with adhesive located in specific areas to allow for the removable adherence to the face of the user and thereby eliminate straps and headbands.

These and other objects of the invention will be brought out in the following part of the specification, wherein detailed description is for the purpose of fully disclosing the invention without placing limitations thereon.

### BRIEF DESCRIPTION OF DRAWING FIGURES

The accompanying drawings, which are incorporated herein and form a part of the specification, illustrate some, but not the only or exclusive, examples of embodiments and/or features. It is intended that the embodiments and figures disclosed herein are to be considered illustrative rather than limiting.

In the drawings:

FIG. 1 depicts the face shields of the system herein which are adapted for adhesive engagement to a face of a user, which are sequentially positioned in a roll, which is adapted for operative engagement within a conventional roll dispenser.

FIG. 1A shows an overhead view of a stack of face shields of the system herein, which are dispensed from the stack thereof, which may be dispensed from a container, such as a box or the like.

FIG. 2 shows the face shields of FIG. 1 showing an alternative non-strap engagement using slits defining apertures located in mounting areas and showing a frangible connection between adjacent shields, which renders the plastic easily separable without damaging either of the adjacent shields.

FIG. 3 depicts a front view of a face shield of the system herein, as in FIG. 1, having a particularly favored shape and configuration, providing mounting locations which projected from side edges which have slits to achieve a frictional non slip engagement upon temples of eyewear worn by the user.

FIG. 4 shows a view of a face shield, as in FIG. 1, but with adhesive sections positioned in the mounting locations projecting from the side edge of the shield, which will hold them to or adjacent the temples of the face of a user to form the strapless engagement.

FIG. 5 shows a strapless engagement of the shield, of FIG. 4, to the face of the user where adhesive sections form the strapless connectors to the temple areas of the face of the user holds the face shield in a curved configuration in front of the face of the user.

FIG. 6 depicts the face shield device of FIG. 4 wherein slits defining apertures are formed in the mounting areas projecting from the side edge of the shield and form a strapless connector which forms a frictional contact on opposing sides of eyewear temples worn by the user.

FIG. 7 depicts the system herein having air filtering face masks which are configured on a rear surface for a strapless adhesive engagement to a user, where the face masks can be torn from a roll positioned on a dispenser.

FIG. 7A shows an overhead view of a stack of individual air filtering face masks as in FIG. 7 but which are dispensed from the stack of face masks which may be positioned in a container such as a box.

FIG. 8 shows a rear side surface of the air filtering face mask herein, showing removable adhesive coverings which cover two different areas encircling the perimeter area of the filtering face mask and showing an arched area of the adhesive configured for sealed engagement on the bridge of the nose of the user.

FIG. 9 depicts the filtering face mask of FIG. 8 showing a first cover on the first adhesive area on the rear surface of the filtering face mask, whereby the first adhesive area my be exposed and engaged to the face of the user, as in FIG. 10.

FIG. 10 shows the rear of the air filtering face mask of FIG. 8-9 where the first adhesive area forming a first adhesive connection with the face of the user is exposed, once the first covering is removed, and a second covering on a second adhesive area on the rear of the face mask is shown being removed.

FIG. 11 shows both the filtering face mask of FIGS. 8-10 where the first adhesive area exposed as well as the second adhesive area being exposed once the respective protective coverings thereon have been removed.

FIG. 12 shows the face masks of FIGS. 8-11 operatively engaged in an adhesive connection to the face of the user wherein a seal if formed around a perimeter area of the face mask and over the bridge area of the nose of the user to prevent airflow causing eyeglass fogging and dry eyes.

### DETAILED DESCRIPTION OF THE PREFERRED EMBODIMENTS OF THE INVENTION

In this description, the directional prepositions of up, upwardly, down, downwardly, front, back, top, upper, bottom, lower, left, right and other such terms refer to the device as it is oriented and appears in the drawings and are used for convenience only. They are not intended to be limiting or to imply that the device has to be used or positioned in any particular orientation.

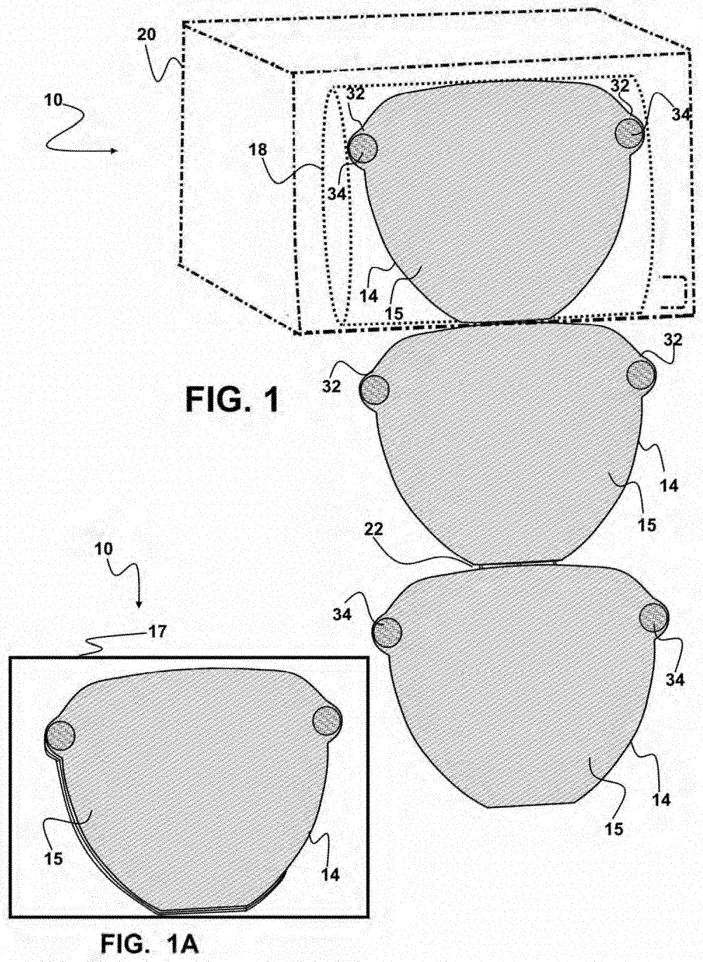

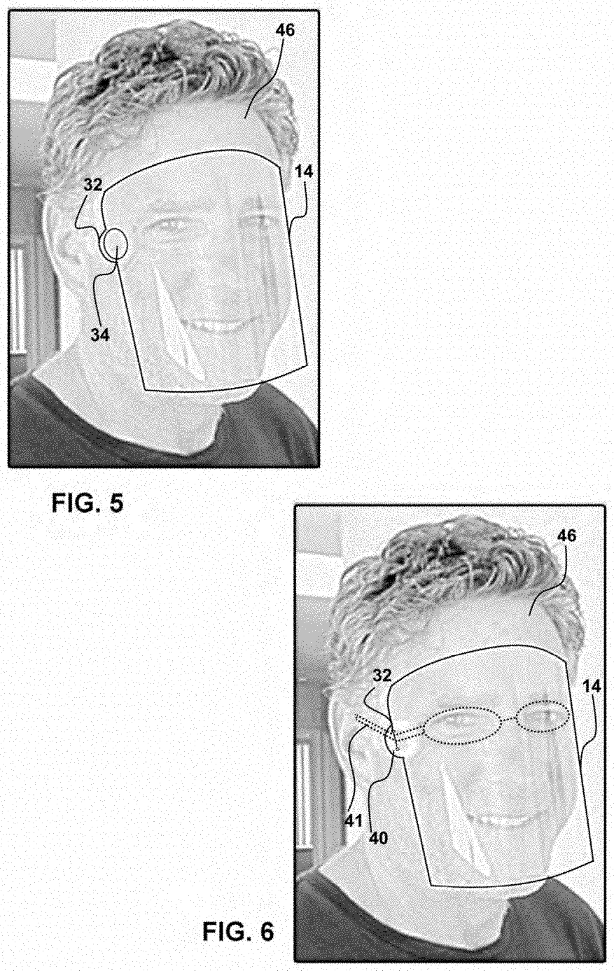

Now referring to drawings in FIGS. 1-12, wherein similar components are identified by like reference numerals, there is seen in FIG. 1 a first mode of the system 10 herein wherein face shields 14 having a shield body 15 formed of substantially clear plastic or polymeric material are configured for a strapless engagement to the face of the user as shown in FIG. 5-6.

As shown in FIG. 1, the shield body 15 of the face shields 14 is configured in a shape adapted for an adhesive engagement to a face of a user. Each of the face shields 14 has a shield body 15 which is sequentially positioned in a roll 18, which is adapted for operative engagement within a conventional roll dispenser housing 20.

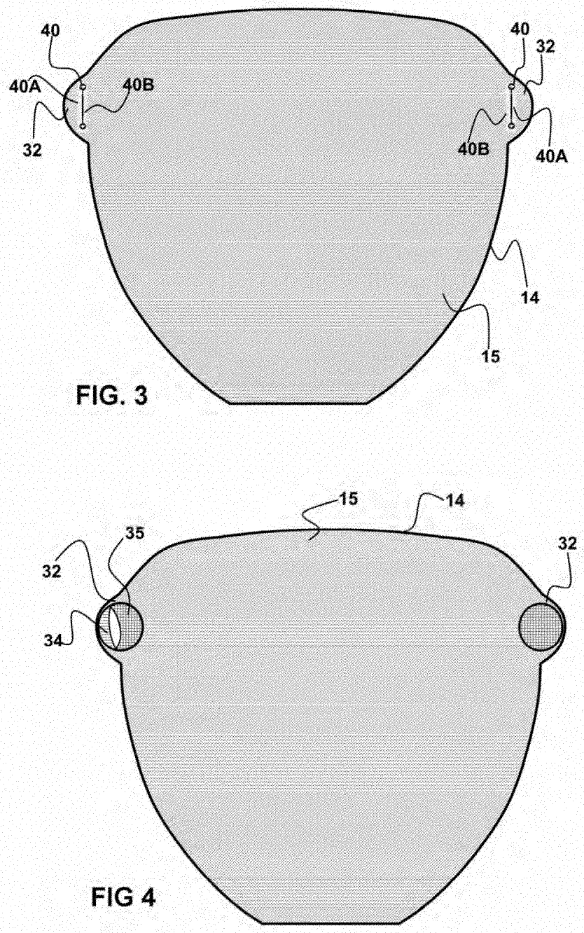

The dispensed face shields 14, as shown in FIG. 1 or 1A, preferably have the configuration of the shield body 15 of FIG. 3 or FIG. 4 which include mounting areas 32 which project from the perimeter edge defining the shield body 14 on opposing sides thereof. The strapless connection to the face of the user is achieved either by the slits 40 shown in FIG. 3 which frictionally engage with two sides of an eyeglass temple 41 as in FIG. 6, or the strapless connection may be achieved by the adhesive sections 34 positioned on the mounting areas 32 of the shield body 15 on the opposing sides thereof as in FIG. 4.

The face shields 14 may be dispensed from a plurality thereof, such as a stack of face shields 14 of the system 10 herein, which may be dispensed from such a stack held in a container, such as a box 17 or the like. Alternatively, and as noted and preferred, to keep the face shields 14 from sticking together, such as with static attraction in a stack, the face shields 14 may be dispensed from a roll 18 thereof, which has a plurality of face shields 14 having a tearable or frangible connection 22 between a first end of one face shield 14 and a second end of the engaged face shield 14.

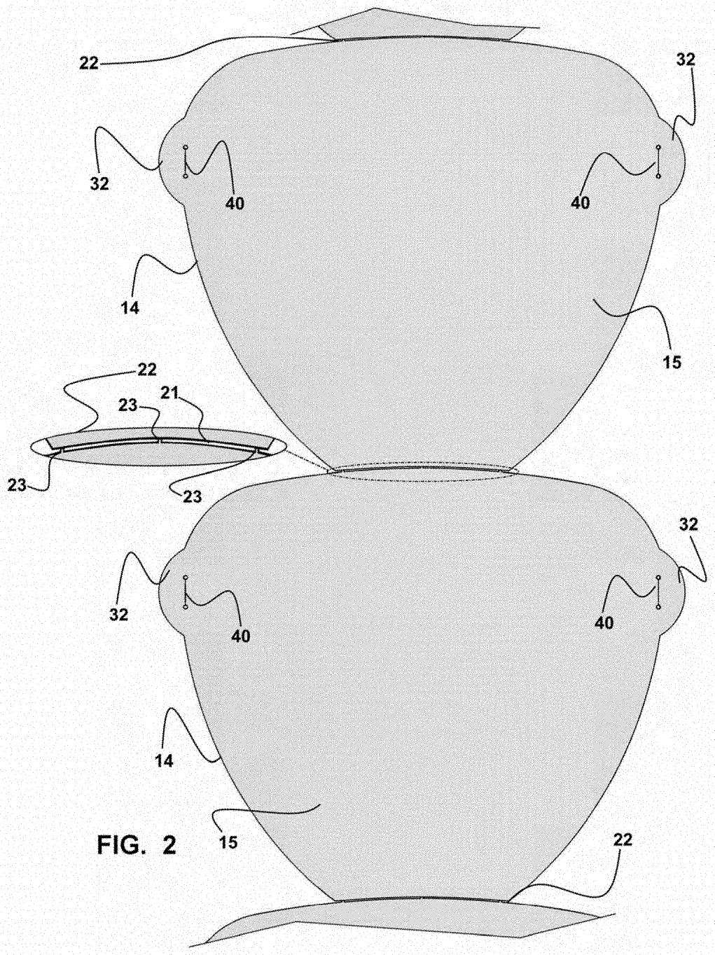

The roll configuration of FIG. 1 is shown enlarged in the depiction of FIG. 2. As shown, the frangible portion 22 located between a first end of one face shield 14 and a second end of the other, has a gap 21 and a plurality of connectors 23 formed of the same polymeric or plastic material forming the substantially transparent shield body 15 of the face shields 14. Currently, three connections 23 have been found in experimentation to allow for a secure engagement but also allow for easy detachment of the shields 14 from each other.

This ease of detachment was found best when the three connectors 23 were between 0.5 mil to 1.5 mils wide, and the transparent plastic or polymeric material forming the shield body is between 4-10 mils in thickness. While a lesser number of connectors 23 may be employed, or another frangible or tearable attachment to achieve the roll 18 dispensing of the face shield 14, the easiest defacement with the least damage or folding or creasing of the adjacent shield bodies 15 was achieved with the three connectors 23 and gap 21 as described.

In FIGS. 3-4 is shown a front view of the transparent shield body 15 of a face shield 14 of the system 10 herein as in FIGS. 1-2. As shown is the particularly favored shape and configuration of the shield body 15 which has mounting areas 32 which project from the perimeter edge of the shield boy 15 on opposing sides thereof. The mounting areas have a connector thereon, which forms a strapless engagement to the face and person of the user. This strapless connector can be provided by either the slits 40 formed into the projecting mounting areas 32, or by adhesive sections 34 positioned thereon which would be covered by a peelable cover 35. Either will form a strapless connection to the head of the user with the shield 14 in an as-used positioning, shown in FIGS. 5-6.

As shown in FIG. 3, the slits 40 formed through the projecting mounting areas 32 of the shield body 15 are preferred. This is because the slit 40, as cut, positions the opposing edges 40A and 40B of each slit 40 touching or almost touching each other, with a separation distance such that the two side edges of each slit 40, which will contact against side edges of an eyeglass temple 41, such as shown in FIG. 6. The separation between the two sides of the slit would best be a distance less than a thickness of an eyeglass temple 41 such as between 1/32 to 1/16 of an inch. This contact of the two side edges 40A and 40B of the slit 40, thus, forms a biased frictional engagement on each side of the temple 41, because the polymeric or plastic material forming the shield body 15 will bend slightly to accommodate insertion of the temple 41, and then contact it biasly.

As noted, in FIG. 4 is shown the face shield 14, as in FIG. 1, but with the strapless connector to the head of a user formed by adhesive sections 34 positioned in the mounting areas 32 which are formed to project from the opposing side edges of the shield body 15. Once the peelable cover 35 is removed from the adhesive section 34, a strapless connection provided by strapless connectors to the face of the user can be achieved by adhering the adhesive sections 34 to the skin of the face of the user. The strapless connection of such adhesive sections 34, positioned on the mounting areas 32, is shown in FIG. 5. As shown a strapless connection is formed by the two adhesive sections 34 to the temple areas of the face of the user.

The face shield 14, in an as-used positioning, in front of the face of a user 46, is shown in both FIGS. 5-6, as noted. In FIG. 5, the strapless connector, as noted, is formed by the adhesive sections 34 engaged with the face of the user 46. In FIG. 6, the as-used positioning is maintained by the strapless connector in the form of the slit 40, where the two side egises 40A and 40B biasly engage the temple 41 (FIG. 3).

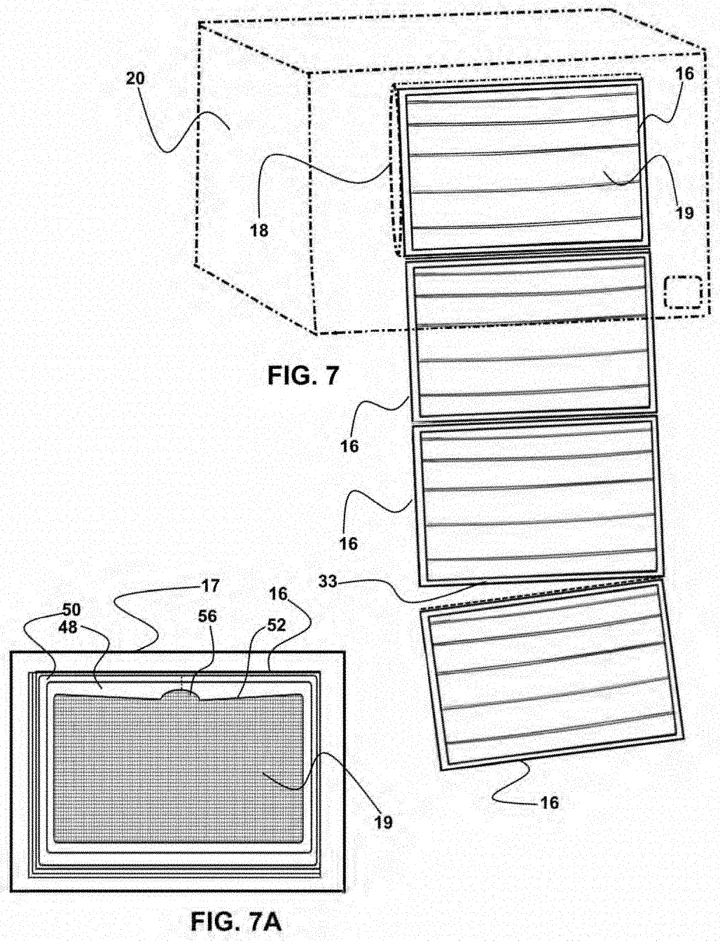

Shown in FIG. 7 is a secondary personal protective component of an air filtering face mask 16 of the system 10 herein which, as noted, may be employed individually or in combination with the face shield 14. As shown, an air filtering body 19 of the face mask 16 is formed of fabric or paper or other material which will filter particulate and pathogens from air breathed by the user 46. Such materials are well known in the art and generally can be layered or pleated or otherwise formed to have passages through the material sized to prevent particulate and pathogens therethrough. The face body 19 is formed currently 3 and ¾ inches tall and 7 inches in width, to allow for good facial coverage but such may vary, and small, medium, and larger sizes can be made.

As shown in FIG. 7 and FIG. 7A, the face masks 16 may be dispensed from a roll 18 where separable areas 33, such as by perforation between the perimeter edge of the face mask body 19, allow for separating each face mask 16 in the roll 18. Just as preferred, the face masks 16 can be individually dispensed from a stack thereof, such as in FIG. 7A which are positioned on a support surface or in a container such as a box 27.

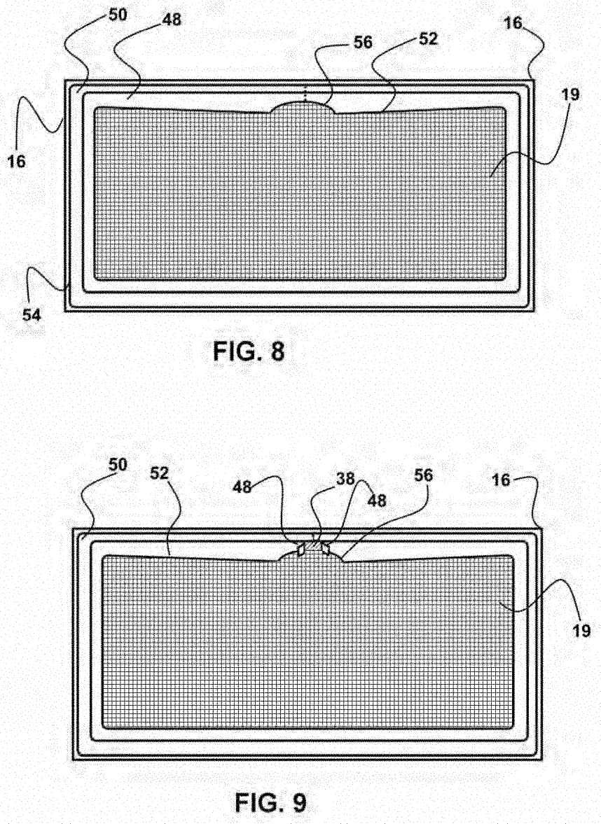

In FIGS. 8-11 are shown a rear side surface of the face mask body 19 for filtering air which passes therethrough which is opposite the front surface shown in FIG. 7. As shown, positioned substantially around the entire perimeter area of the mask body 19, are the strapless connector therefor in the form of a first adhesive area 38 and a second adhesive area 39. The first adhesive area 38 is covered initially by a first cover 48 and the second adhesive area 39 is covered by a second cover 50, both of which can be peeled away to expose the underlying adhesive area 38 or 39. One or both of the first adhesive area 38 and second adhesive area 39 form the strapless connector to hold the face mask 16 to the face of a user 46. Such is shown in FIG. 11, where the face mask 16 is held in a strapless but substantially sealed engagement of the perimeter area 54 upon the face of a user 46.

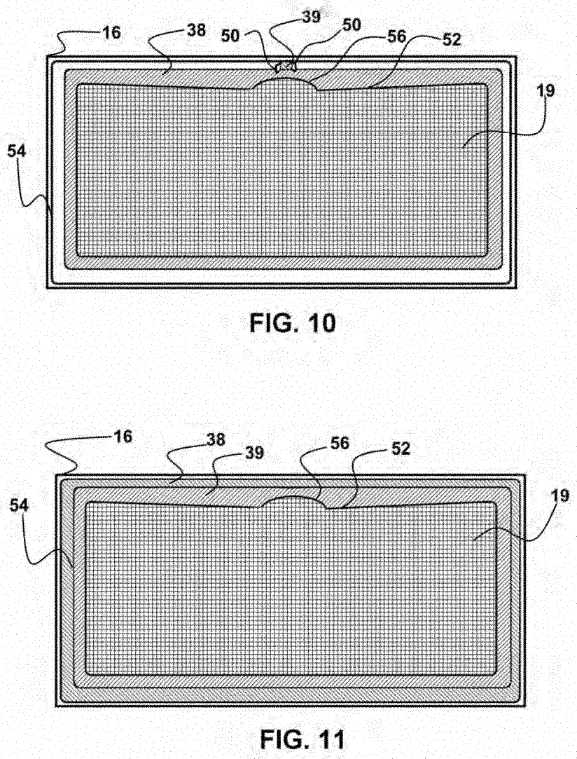

Each of the first adhesive area 38 and second adhesive area 39 are configured to form an annular or ring-like seal around substantially an entire perimeter area of the face mask 16 face body 19 to form a sealed attachment to the face of a user 46. The face mask 16 can be straplessly connected in a first configuration, such as in FIG. 10, where only the first adhesive area 38 is exposed, and will hold the face mask 16 on the user 46 as in FIG. 11.

The user 46, thus, removes the face mask 16 temporarily such as for a work break or eating or such, and if the face mask 16 will not adequately form a seal around the perimeter area 54, the second cover 50 may be removed from the second adhesive area 39, and the face mask 16 can be reengaged with substantially a sealed engagement to the face of the user 46 around the perimeter areas 54 provided by the second adhesive area 39 in combination with the first adhesive area 38. This mode of the face mask 16 is especially preferred as a means to use less face masks 16 at venues using them since the sealed engagement around the perimeter area 54 can be renewed.

While shown as annular or ring like formations completely encircling the perimeter areas 54 of the face mask body 19 of air filtering material, to thereby prevent air from circumventing it, there could be small gaps therein and still yield a strapless connector to the face of a user 46 which allows for removal and re engagement once the second cover 50 is removed from the second adhesive area 38. However, where such may occur or be configured, the second adhesive area 39, surrounding the interior located first adhesive area 38, will generally still provide a sealed engagement to the face of a user 46 that will prevent passage of air around the filtering fabric forming the face mask body 19.

Additionally preferred, in all modes of the protective face mask 16 portion of the system 10, whether used alone or in combination with a shield, is the curved recess 56 formed into the interior edge of and defining a central portion of the first adhesive area 38. An enhanced sealed engagement of the first adhesive area 38, over and around the bridge 60 of the nose of a user, was found after much experimentation to be yielded by this curved recess 56 formed into the interior edge of the first adhesive area 38.

As can be seen in FIGS. 10-11 this interior edge 52 surrounds the filtering material forming the face mask body 19. The interior edge 52 angles downward from the top two corners of the mask body 19 to form the central portion of the first adhesive area 38 wider than the first adhesive area 38 adjacent and along the opposing sides. The relief area provided by the curved recess 56 formed into the interior edge 52 made the central area defined by the area of the recess 56 more flexible and better engaged over the bridge 60 area of the nose. The two wider areas of the first adhesive area 38 formed by the downward angling interior edge 52, position wider portions on opposing sides of the nose of the user. The formed sealed engagement allows the face mask 16 to eliminate the uncomfortable wires used in conventional masks to achieve a sealed engagement over the nose which prevents exhaled are from moving upward and from fogging glasses and the like.

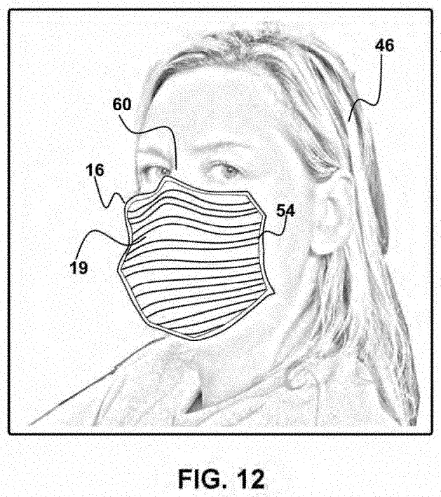

As noted, FIG. 12 shows the face mask 16 of FIGS. 8-11 operatively engaged in an adhesive connection to the face of the user. As shown, a seal is formed around a perimeter area 54 of the face mask body 19, and also over the bridge area 60 of the nose of the user 46. If the second adhesive area 39 has not been exposed, the face mask 16 can easily be removed from this as-used engagement for a duration of time, and then reattached with a significantly better seal which is afforded by the second adhesive area 39 once the second cover 50 is removed before such re attachment.

While all of the fundamental characteristics and features of the protective face covering system have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are considered included within the scope of the protective face covering system invention as defined herein and by the following claims.

What is claimed is:

1. A protective face covering apparatus, comprising:
a substantially transparent face shield, said face shield having a shield body, said shield body having a first side opposite a second side, said body having a first end opposite a second end;
a first mounting area on said first side of said shield body;
said first mounting area having a first strapless connector thereon, said first strapless connector positionable to a first connection with a face of a user;
a second mounting area on said second side of said shield body;
said second mounting area having a second strapless connector thereon, said second strapless connector positionable to a second connection with a face of a user; and
said first connection with said face of said user in combination with said second connection with said face of said user removably holding said face shield to an as-used positioning with said body in front of the eyes and mouth of said user.

2. The protective face covering apparatus of claim 1, additionally comprising:
said first strapless connector being a first adhesive section positioned on said first mounting area;
said second strapless connector being a second adhesive section positioned on said second mounting area;
said first connection with said face of said user being a first adhesive engagement thereto, of said first adhesive section; and
said second connection with said face of said user being a second adhesive engagement thereto, of said second adhesive section.

3. The protective face covering apparatus of claim 1, additionally comprising:
said first strapless connector being a first slit formed through said body at said first mounting area;
said second strapless connector being a second slit formed through said body at said second mounting area;
said first connection with said face of said user being an engagement of said first slit around a first temple of eyewear worn by said user;
said second connection with said face of said user being an engagement of said second slit around a second temple of said eyewear worn by said user.

4. The protective face covering apparatus of claim 2, additionally comprising:
said first mounting area being a first projecting portion of said shield body extending from said first side of said shield body; and
said second mounting area being a second projecting portion of said shield body extending from said second side of said shield body.

5. The protective face covering apparatus of claim 3, additionally comprising:
said first mounting area being a first projecting portion of said shield body extending from said first side of said shield body; and
said second mounting area being a second projecting portion of said shield body extending from said second side of said shield body.

6. The protective face covering apparatus of claim 4, additionally comprising:
a plurality of said face shields positioned on a roll of adjacently positioned shield bodies, each shield body having said first end thereof in a frangible engagement with a second end of a said adjacently positioned shield body, whereby a user can remove one of said plurality of face shields for positioning to said as-used position, by a tearing of said frangible engagement.

6. The protective face covering apparatus of claim 5, additionally comprising:
a plurality of said face shields positioned on a roll of adjacently positioned shield bodies, each shield body having said first end thereof in a frangible engagement with a second end of a said adjacently positioned shield body, whereby said user can remove one of said plurality of face shields for positioning to said as-used position, by a tearing of said frangible engagement.

8. A face mask apparatus comprising:
a face mask having a face mask body formed of air filtration material;
a first adhesive area having an inner edge thereof, said inner edge substantially surrounding a central area of said face mask body;
a second adhesive area, said second adhesive area forming a ring substantially surrounding all of said first adhesive area;
said first adhesive area having a first cover thereon, said first cover being removable from said first adhesive area;
said second adhesive area have a second cover thereon, said second cover being removable; and
said face mask body being engageable in a first adhesive engagement of said first adhesive area to the face of a user, to an as-used positioning thereon, with said first cover removed from said first adhesive area, and with said second cover being positioned upon said second adhesive area.

9. The face mask apparatus of claim 8, additionally comprising:
said face mask body being engageable in a second adhesive engagement of said second adhesive area to the face of a user, subsequent to a disengagement of said first adhesive engagement, by removal of said second cover from said second adhesive area, and a repositioning said mask to said as-used position.

10. The face mask apparatus of claim 8, additionally comprising:
a recess depending into said inner edge of said first adhesive area adjacent a top end of said face mask body;
a length of said recess defining a central portion of said first adhesive area adjacent said top end of said face mask body; and
said central portion of said first adhesive area positionable to a sealed engagement with a bridge area of a nose of said user with said mask in said as-used position, whereby exhaled air from said user is blocked by said sealed engagement from exhausting said top portion of said face mask.

11. The face mask apparatus of claim 9, additionally comprising:
a recess depending into said inner edge of said first adhesive area adjacent a top end of said face mask body;
a length of said recess defining a central portion of said first adhesive area adjacent said top end of said face mask body; and
said central portion of said first adhesive area positionable to a sealed engagement with a bridge area of a nose of said user with said mask in said as-used position, whereby exhaled air from said user is blocked by said sealed engagement from exhausting said top portion of said face mask.

12. The protective face covering apparatus of claim 2, additionally comprising:
the face mask apparatus of claim 9;
said face covering apparatus of claim 1 forming a substantially transparent shield positioned in front of an area of a face of said user, said area including the eyes, nose, and mouth of said user; and
said face mask apparatus of claim 9 forming an air filtering covering in contact with said face of said user in a filtering area, said filtering area covering said nose and said mouth of said user.
